(19) United States
(12) Patent Application Publication
(10) Pub. No.: US 2017/0266075 A1
(43) Pub. Date: Sep. 21, 2017

(54) Aid device for the movement and/or rehabilitation of one or more fingers of a hand

(71) Applicant: Telerobot Labs S.r.l., Genova (IT)

(72) Inventors: Francesco Becchi, Genova (IT); Patrizio Sale, Roma (IT); Wiktor Sieklicki, Gdansk (PL); Giovanni Stellin, Genova (IT)

(21) Appl. No.: 15/612,173

(22) Filed: Jun. 2, 2017

Related U.S. Application Data
(63) Continuation of application No. PCT/IB2015/059313, filed on Dec. 3, 2015.

(30) Foreign Application Priority Data
Dec. 4, 2014 (IT) GE2014A000120

(51) Int. Cl. A61H 1/02; A63B 21/00; A63B 23/16; A63B 21/005

(52) U.S. Cl. CPC A61H 1/0288; A63B 21/0058; A63B 21/00178; A63B 23/16; A61H 2205/067; A61H 2201/1635; A61H 2201/1207; A61H 2201/1238; A61H 2201/5061; A61H 2201/5064; A61H 2201/501

(57) ABSTRACT

An aid device for the movement and rehabilitation hand fingers includes a exoskeleton, an articulated glove or a wearable mechanism configured to be positioned on the back of at least one finger and to be mechanically constrained to the finger, and a motorized system exerting a movement or a change in the configuration of the exoskeleton. The exoskeleton includes a rigid elements arranged on a row one behind the other along a longitudinal axis parallel to the longitudinal extension of the finger and articulated with each other to make a modular underactuated structure and obtain maximum shape and kinematic adaptability to the fingers, particularly to follow the extension and flexing movement of the fingers. The motorized system includes pulling and/or pushing elements that act on one or more of the elements of the exoskeleton to produce finger movements and particularly the extension and flexing movements of the fingers.

### FIELD OF THE INVENTION

The present invention relates to an aid device for the movement and/or rehabilitation of one or more fingers of a hand, comprising an exoskeleton intended to be positioned on the back of at least one finger and to be mechanically constrained to the finger itself and motorized means for exerting a change in the configuration of said exoskeleton.

### BACKGROUND OF THE INVENTION

The loss of hand mobility is a common disease that often can be caused by cortical lesions due to cerebrovascular diseases or due to a stroke. Stroke every year affects about 0.2-0.5% of the population of industrialized countries in the world and 1.5-3% of the population survives such disease. Generally 76-88% of stroke survivors are affected by motor impairments, 70% of them has the arm functionality temporarily altered. At the same time about 40% of stroke survivors are affected by a permanent loss of functionality in the affected arm.

Rehabilitation can help in restoring at least a part of the lost mobility of one hand and therefore can help in generally improving the quality of life.

Everyday activities such as eating or getting dressed can be regained by hand rehabilitation programs. The efficacy of the several rehabilitation therapies can be influenced by a series of factors that interact with each other and that make the therapies difficult especially in case of long-term disability.

Recent searches have proved that the robotic therapy involves the possibility of an intense motor activity based on a task-oriented training. Such activity aiming at performing a specific task provides a great number of specific movements that have to be carried out for completing the task and that are repeated many times. The use of a robotic device for carrying out such therapy reduces costs of a post-stroke treatment while minimizing the time therapists dedicate to a single patient and it increases meanwhile the therapy intensity, thus making it more efficient.

Moreover for the patients that are not able to regain the functional autonomy of the hand and in particular of the fingers, the use of a robotic device allows help to be given for performing the movements necessary for the daily activities.

It is clear that the application of the device can be extended to all the activities helping the mobility or motor rehabilitation regardless of the reasons that have generated the disabilities of the patients, therefore in addition to merely neurological reasons deriving from a stroke, the device according to the present invention is applied also for the rehabilitation of limbs and particularly of the hand due to disabilities deriving from orthopedic trauma.

In the robotic rehabilitation therapy exoskeletons are used by means of which it is possible to minimize the effects of the loss of functionalities of the limb and particularly of the hand by the fact that said exoskeletons complete the kinematic chain of the hand by the external system.

With reference to the hand, the exoskeleton is a mechanical structure directly connected to a hand and designed such that its kinematic behavior corresponds to the kinematic behavior of the hand and such that the two coupled systems can exchange forces and reaction forces. In order to obtain a coherent movement and a working area of the exoskeleton suitable for the hand, the device has to be designed by considering the kinematic constraints such as mobility and degrees of freedom of the fingers, considering also the limited space available for the mechanism. The fact of designing a light structure able to closely cooperate with human fingers and having a direct contact with the human skin is very difficult and currently the developed exoskeleton systems cannot be considered complementary with the human hand for the whole complete range of movements and functionalities. With reference to the control system, it is further necessary to provide to arrange force sensors and position encoders for properly carrying out the movements of the fingers.

### SUMMARY OF THE INVENTION

The object of the present invention is to develop a device of the type described hereinbefore for helping the rehabilitation of fingers that have lost the motor functionality and that contemporaneously is suitable for guaranteeing the functional mobility of the hand in patients with no expectations of regaining the autonomous functionality of fingers.

In particular the object of the present invention is to provide a device of the above mentioned type overcoming the drawbacks of the known devices and that, as regards the kinematic and encumbrance perspectives is in compliance with kinematics and dimensions, anatomy and morphology of the hand.

The invention achieves the objects mentioned above by a aid device for the movement and/or rehabilitation of one or more fingers of a hand, comprising a exoskeleton intended to be positioned on the back of at least one finger and to be mechanically constrained to the finger itself and motorized means for exerting a movement or a change in the configuration of said exoskeleton, in which device said exoskeleton comprises an underactuated modular structure, comprising a plurality of substantially identical rigid elements arranged on a row and articulated with each other.

A preferred embodiment provides an aid device for the movement and/or rehabilitation of one or more fingers of a hand, comprising a exoskeleton intended to be positioned on the back of at least one finger and to be mechanically constrained to the finger itself and motorized means for exerting a change in the configuration of said exoskeleton, wherein said exoskeleton comprises a plurality of rigid elements arranged on a row one behind another along a longitudinal axis parallel to the longitudinal extension of the finger and are articulated with each other such to follow the extension and closure movement of the fingers and said motorized means are composed of pulling and/or pushing means that act on one or more of said elements of the exoskeleton such to cause the extension and contraction movement.

In particular according to one embodiment limited to carry out an action extending the fingers, the device according to the invention comprises a series of rigid structures positioned on a back surface of the hand and of the fingers along its length and which structures are connected with each other such to be separated and rotated one with respect to each other for a predetermined distance and for a predetermined specific angle respectively. The actuation force is transmitted by a direct current motor, through all the mechanism, to the distalmost rigid structure of the exoskeleton by using a cable such to exert a pulling action resulting in a movement straightening the whole exoskeleton.

Such straightening is due to the reaction forces induced among the rigid elements of the structure that are generated upon driving the mechanism, therefore a finger that is connected to the exoskeleton from the last phalange is obliged to follow the movement of the exoskeleton and to adapt itself to the shape (in this case extended shape) thereof.

A particular embodiment provides the rigid elements of said exoskeleton to be constrained with each other by means of a continuous longitudinal element composed of a chain having links that are articulated with each other according to parallel articulation axes, which are oriented parallel to the articulation axes of the phalanges of the finger in the extension and closure movement thereof,

the rigid elements pivoting with respect to each other according to parallel articulation axes, which axes are oriented parallel to the articulation axes of the finger phalanges, and are movable near and away from each other, each one of said rigid elements being pivotally fastened about an axis of articulation of two chain links with respect to each other,

there being provided at least one pulling element passing through the rigid elements and freely slidable therethrough, which pulling element is flexible and constrained at one end to the end element placed at the distal end of the finger and at the opposite end to a pulling member.

Further advantageous characteristics of the invention are the subject matter of the dependent claims.

In particular in its most complete configuration the device provides an exoskeleton associated to each finger of the hand and the possibility of controlling in an active or passive manner both the extension and flexion movements, and the adduction and abduction movements of the fingers as well as the thumb opposition movements.

A preferred embodiment on the contrary provides an intermediate solution, wherein the exoskeleton is associated only to some fingers and especially to the index, middle, ring and little fingers, while no exoskeleton is associated to the thumb.

Moreover advantageously the device in any of its versions with an exoskeleton for each one or more of the fingers of the hand is made as a wearable device as a glove or an assembly of glove parts.

Although the detailed embodiment described below relates to a variant providing only the action extending, that is straightening, the fingers, the invention can be extended, in an obvious manner for the person skilled in the art, also to one embodiment where also the flexion movement of the fingers can be controlled. With a specific reference to the embodiment described and shown, the double functions namely adduction and abduction can be obtained by using for example push-pull cables that therefore are able to exert both a pulling and a pushing action.

As regards the movement actuating means, both the motors and the movement transmission means can be of different type and are not intended as being limited only to the provision of push or pull cables and motors of the electric type, but they can comprise any type of driving/actuating system such as for example pneumatic or hydraulic systems.

As it clearly results from the present description, claims and from the detailed description of one embodiment in the annexed figures, by means of its configuration, unlike the known devices, the device according to the present invention easily meets a series of bonds and specification necessary for efficaciously carrying out exercises for recovering reduced or lost mobility of the hand and also for being used as an aid for mobility in case of permanent loss of hand mobility, which are listed below:

(a) the movement made possible by the device covers most (if not all) of the working positions of the fingers including those providing the fingers completely flexed and the fingers straightened (extended); in particular such adaptability allows also spastic conditions of the joints to be imitated such as for example in the case of the “claw” hand with the metacarpus-f extended and the phalange-IF flexed;

(b) the space necessary for grasping objects with a pinching grasp or power grasp is free and therefore no parts of the device can extend inside said space;

(c) the device allows the fingers to be operated all together or in a manner independently from each other;

(d) in case of the index, ring, middle and little fingers the mobility of all the three joints—MCP, Proximal Interphalangeal Joint (PIP) and Distal Interphalangeal Joint (DIP) is provided and the extension of the driven movement allows a user to open the hand without having a hyper-extension and to close the fingers to grasp a small object;

(e) the patients that survived a stroke usually have more problems in opening the fingers than closing them, thus the device is specifically made for helping the mobility in the opening movement;

(f) the handling of the pain both when coupling the hand to the device and when exerting the action extending the fingers is important and therefore the possible pain is minimized;

(g) the assistance function of the device requires fingers to be moved with a speed allowing objects slowly moving in our usual environment to be grasped. Since such requirement is highly subjective and has to be defined by clinical tests the movement speeds of the device are adjustable depending on empirically defined parameters;

(h) the exerted forces are enough for extending the fingers till reaching the straight position also in case of complete opposition;

(i) the dimensions of the whole system are such to allow patients to carry out a rehabilitation at home such that the treatment is not an obstacle for their daily activities and allows it to be used at home, reducing the travel costs for the patient to a rehabilitation center;

(j) the device can be implemented by a “plug and play” technology that allows a computer to be connected and which can be powered by batteries or by the computer itself.

In an early step of the rehabilitation process the finger movement can be carried out with the complete assistance of the robotic system, while in the final steps of the rehabilitation better results can be achieved by using the system only for improving the human autonomous movements and for helping in reaching a complete range of movements of the joints. Therefore the system can operate in two modes one of which with a completely active finger position control and one with a semi-active control.

According to a further improvement, in order to maximize the effects of rehabilitation, exercises are combined with a visual feedback software that can be executed by a personal computer. Thus it is possible to avoid the patient from being demotivated by being bored.

Exercises can be combined with a rehabilitation program in the form of a goal-oriented game and with difficulty levels that are modified on the basis of the progresses achieved in the rehabilitation and corresponding to the success level in the games.

The device according to the present invention further comprises a control unit that has a human operator interface.

The control unit can be made according to hardware-software constructional modes currently in use and available on the market.

More specifically, it is possible to provide at least the following modes:

direct control by activating the opening command by an interface (a standard button or a sw interface);

direct control of the activation by electromyography feedback by a suitable system capturing and interpreting the signals from the muscles (existing technology and whose integration is provided);

“automatic” control depending on the rehabilitation programs mentioned above.

The design of a system complementary to the human hand is impossible without defining the suitable dimensions of generic human fingers and their mobility. From the kinematic perspective, the length of each phalange defines the distance between the joints or, as in the case of distal phalanges, between DIP and the 5 tip of a finger such as shown by the following table 1.

With reference to the little, ring, middle, and index finger the length of the metacarpus is not important since the metacarpus is expected not to have a relative motion with respect to the hand palm.

In the tables below and in the description with the acronyms MIP, PIP DIP and MTC we mean the intermediate phalange, the proximal phalange, the distal phalange and the metacarpus respectively.

TABLE 1
Length of the phalanges of the human fingers

| | Length [mm] ([1]/[2]/resulting) | | | | |
|---|---|---|---|---|---|
| | Finger | | | | |
| Phalange | Thumb | Index | Middle | Ring | Little |
| Metacarpals | 46.2/51.2/48.7 | — | — | — | — |
| Proximal | 31.6/40.0/35.8 | 39.8/45.5/42.7 | 44.7/42/43.4 | 41.4/— | 32.7/— |
| phalanges | | | | | |
| Intermediate | — | 22.4/26.0/24.2 | 26.3/30.9/28.6 | 25.6/— | 18.1/— |
| phalanges | | | | | |
| Distal | 27.3/32.2/29.8 | 19./23.0/24.4 | 21.3/25.9/23.6 | 21.2/— | 19.7/— |
| phalanges | | | | | |

The device according to the present invention allows a control to be exerted on the flexion/extension of MCP, PIP and DIP joints of index, middle, ring and little fingers. The thumb is considered as being constrained by an orthosis or a splint. The range of the movements of each one of the three joints is shown in the table 2 below:

TABLE 2
Range of the angular movement of the joints

| | Range of movements [*] | | | |
|---|---|---|---|---|
| | MCP | | PIP | DIP |
| | Abduction- | Extension- | Extension- | Extension- |
| Finger | Adduction | Flexion | Flexion | Flexion |
| Index | −20:20 | 0:80 | 0:90 | 0:70 |
| Middle | −20:20 | 0:80 | 0:90 | 0:70 |
| Ring | −20:20 | 0:80 | 0:90 | 0:70 |
| Little | −20:20 | 0:80 | 0:90 | 0:70 |

The maximum forces that can be applied to each phalange while a grasping movement is being performed are shown in table 3 by the first value, while the second value shows the fingers in the null and straightened condition. The forces shown for the thumb have been measured in the configuration with the thumb pushed against the index finger, which seems to be the configuration allowing the maximum force to be produced.

TABLE 3
Maximum forces exerted by the human fingers by the
intermediate phalange during a grasp/null configuration

| | Force (N) ([9[]/[10]) | | | | |
|---|---|---|---|---|---|
| | Finger | | | | |
| Phalange | Index | Middle | Ring | Little | Thumb |
| Proximal | 42/— | 24/— | 15/— | 7/— | — |
| phalanges | | | | | |
| Intermediate | 22/— | 40/— | 28/— | 20/— | — |
| phalanges | | | | | |
| Distal | 62/50 | 68/50 | 44/40 | 31/— | 109 |
| phalanges | | | | | |

In literature, the rotational velocity of the PIP joint is 10 rad/s for the “natural velocity” movement and 3-6 rad/s for the MCP joint and the PIP joint in the “slow” movement. The “normal” movement velocities of the fingers is about three times slower than the maximum one—in 10 s the fingers can be closed and opened about 8 times, with a consequent velocity of MCP and PIP joints of about 3 rad/s and the related velocity of DIP joint is about 2 rad/s.

### BRIEF DESCRIPTION OF THE DRAWINGS

The characteristics listed above and other characteristics and advantages of the present invention will be more clear from the following description of some embodiments shown in the annexed drawings wherein:

FIG. 1 is a side view of a first embodiment of the device according to the present invention in the form of a wearable glove and with one exoskeleton only for the middle finger.

FIG. 2 illustrates a further embodiment of the device according to the present invention, still of the wearable type, but with an exoskeleton for each index, middle, ring and little fingers and wherein the glove is replaced by individual glove parts intended to be worn on predetermined parts of the fingers and of the hand.

FIG. 3 is a view of the hand palm wearing the device according to FIG. 2.

FIG. 4 is a view of the hand with the device of FIGS. 2 and 3 taken from a direction of view on the distal ends of the fingers.

FIG. 5 is a top view of a limb wearing the device according to the preceding FIGS. 2 to 4.

FIG. 6 schematically is a rigid element of the exoskeleton.

FIG. 7 illustrates a chain segment for connecting the exoskeleton rigid elements with each other.

FIG. 8 illustrates two rigid elements in a condition angularly offset from each other.

FIG. 9, like FIG. 8, illustrates three rigid elements in the angularly offset condition.

FIGS. 10, 11 and 12 schematically illustrate three different embodiments of a variant embodiment of the invention wherein the exoskeleton rigid elements are connected with each other by a continuous flexible element composed of a sequence of flexible connection elements made in order to have an overall deformation on a preferential flexion plane.

### DETAILED DESCRIPTION OF EMBODIMENTS OF THE INVENTION

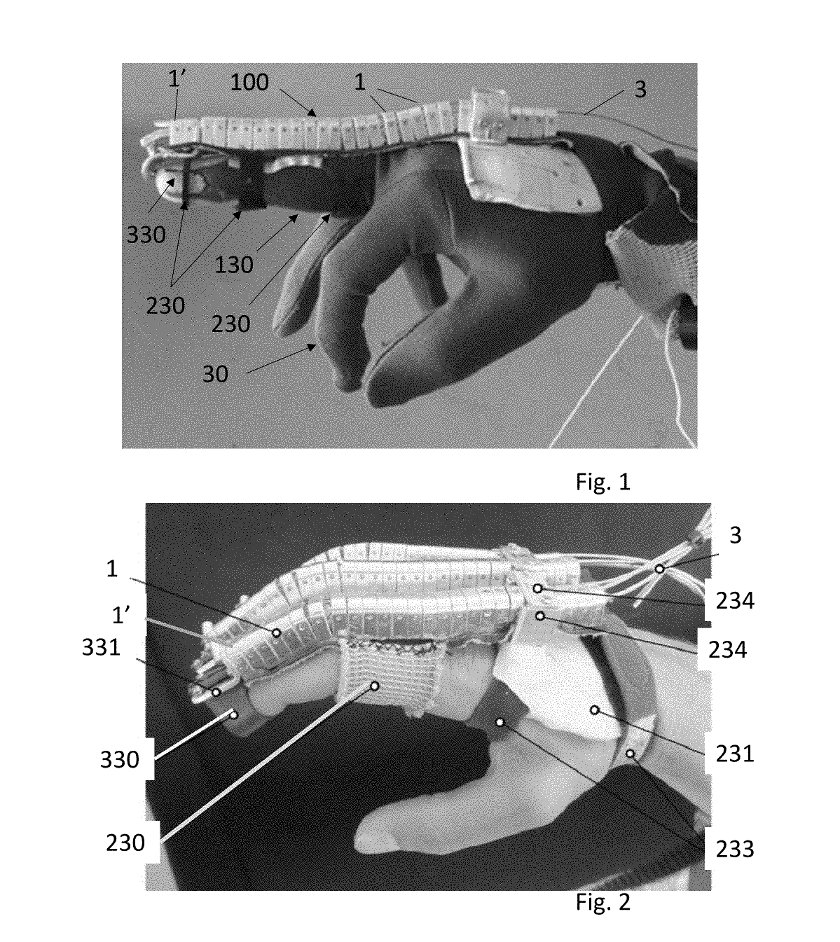

With reference to FIG. 1, a device according to the present invention has been initially configured as a glove 30 to be worn. The glove 30 on the back side of at least one finger 130 of the glove has an exoskeleton structure 100 intended to force the finger on which the glove 30 is worn to take the extended condition, namely the straight condition. The finger of the glove 30, in this case, generates the mechanical constraint between the finger of the hand and the exoskeleton.

In particular the mechanical constraint between the exoskeleton and the finger of the hand can be further strengthened by means of clamping elements 230 provided at predetermined points of the finger and of the hand and for example made in the form of clamping annular bands or strips 230 that are wound around the finger.

As it will be more clear from the following description, a tension rod 3 in the form of a cable slidably passes through the series of rigid elements 1 that form the exoskeleton structure and that adhere on the back side of the finger. Therefore the tension rod freely passes through each one of the rigid elements 1 and it is fastened by its distal end only to at least one of the rigid elements 1′ provided at the distal end of the exoskeleton. Said distal rigid element 1′ is constrained with the distal phalange by a clamping band 230 and a cap element 330 that is inserted on the end of the distal phalange or a terminal coupling to said distal end of the distal phalange.

In the variant of FIG. 2 and in the following ones the device provides a separated and dedicated exoskeleton for each index, middle, ring and little finger, while the thumb is immobilized in the movement by an orthosis.

In order to adapt itself to the dimensions and to the complex kinematics of the fingers each exoskeleton is composed of a serial underactuated mechanism, meaning a mechanism having a lower number of actuators than degrees of freedom. In particular the exoskeleton is made as a grasping underactuated mechanism moved by cables.

Each man-machine interaction system that directly contacts the human skin should provide wearing and use comfort. No pain and no unpleasant skin irritation have to be caused by any device. In the case of the device shown in FIG. 1 and in the following ones, the pressure is applied to the back side of the finger when exerting the action forcing the finger in the straight position. Such pressing action is mainly exerted at the areas of the joints. To this end, a foam-fabric pad is placed on the finger.

The fingertip is another point where the force extending the finger is directly applied. According to a possible advantageous solution, in the device according to the present invention there are provided natural leather strips wound in the form of cylindrical bushings. Such solution provided in the embodiments of FIGS. 2 to 5 permits a good adaptation to the different dimensions of the tip of the fingers and it reduces the painful effects at the tip of the finger when the finger is forced in the extended condition. At the same time such solution allows a certain level of tactile perception for the fingertip to be guaranteed and it is less bulky.

The end bushings made of leather act as fingerstalls where the end of the distal phalange of the corresponding finger is inserted. Said bushings have the same reference numeral 330 of the analogous element provided in the embodiment of FIG. 1.

Moreover as it results from FIGS. 2, 4 and 5 the leather band forming each end bushing or end fingerstall 330 is locked by being clamped by a terminal 331 on the distal end of the exoskeleton that rests against the last rigid element 1′ at the distal end of the exoskeleton 100. Said terminal 331 at the same time is an abutment holding an enlarged head of the corresponding pull cable 3. Said enlarged head is composed of an end clamp 332 tightened on the free distal end of the cable protruding past the distal rigid element 1′ and the associated terminal 331.

As it results from FIGS. 2, 4 and 5 the system is connected to the palm by a semi-rigid plate 231 that is clamped on the hand by means of two straps 232 with the connection for the fastening to the plate 231 composed of closures 233 of the hook and loop fastening type. Said rigid plate 231 is made of a thermoplastic material and this allows the surface of contact between the hand and the device to be maximized. The arrangement further minimizes the contact pressure, while it does not limit the movements of the fingers and of the wrist although the device is firmly fastened to the hand.

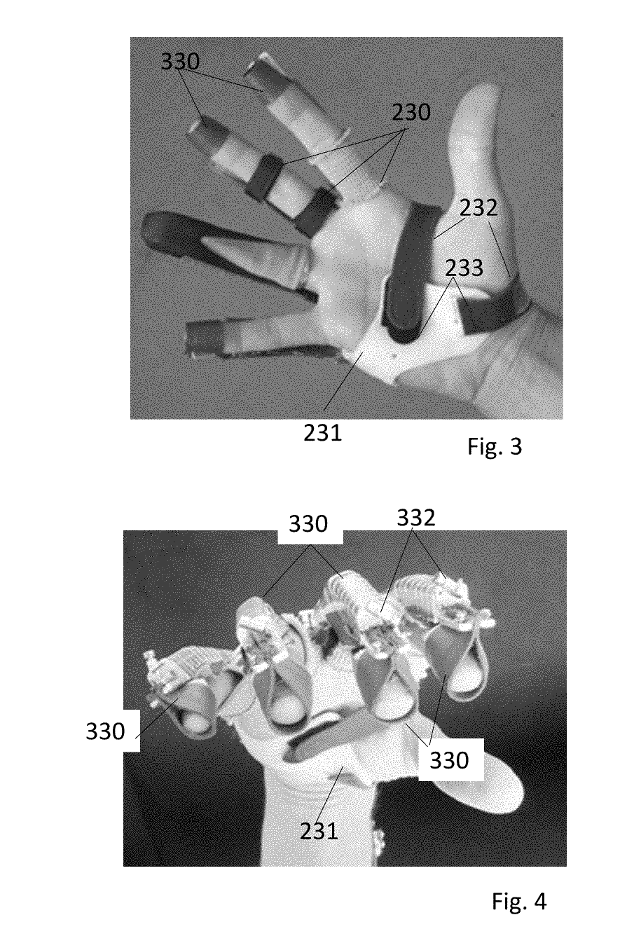

Still with a particular reference to FIGS. 2, 3 4 and 5 the device in its preferred configuration comprises the rigid thermoplastic plate 231 that wraps a part of the back of the hand starting from the attachment of the thumb turning around the external side of the hand and extending also on the palm thereof (see FIG. 3). The two ends of the rigid thermoplastic plate 231 are fastened to the hand by means of clamping belts fastened to the part of the plate 231 by means of coupling means of the hook and loop type or the like. The plate 231 at the back side of the hand has exoskeleton mounting brackets, denoted by 234, that can rotate and that permit freedom in abduction/adduction movements of the fingers.

The main component of the system which is the series of rigid elements 1 arranged on a row with the means for limiting the distance between said rigid elements, is connected to the finger by a leather strip whose edges are held by the terminal 331 such to form distal fingerstalls housing the ends of the distal phalange of the respective finger and of an annular fabric band 230 provided in an intermediate position of the longitudinal extension of the finger, particularly at the proximal phalange. The pull cable 3 passes through all the elements and it is fastened to the last rigid element as disclosed above. The pull cable is guided to the pulling motorized assembly by a sheath.

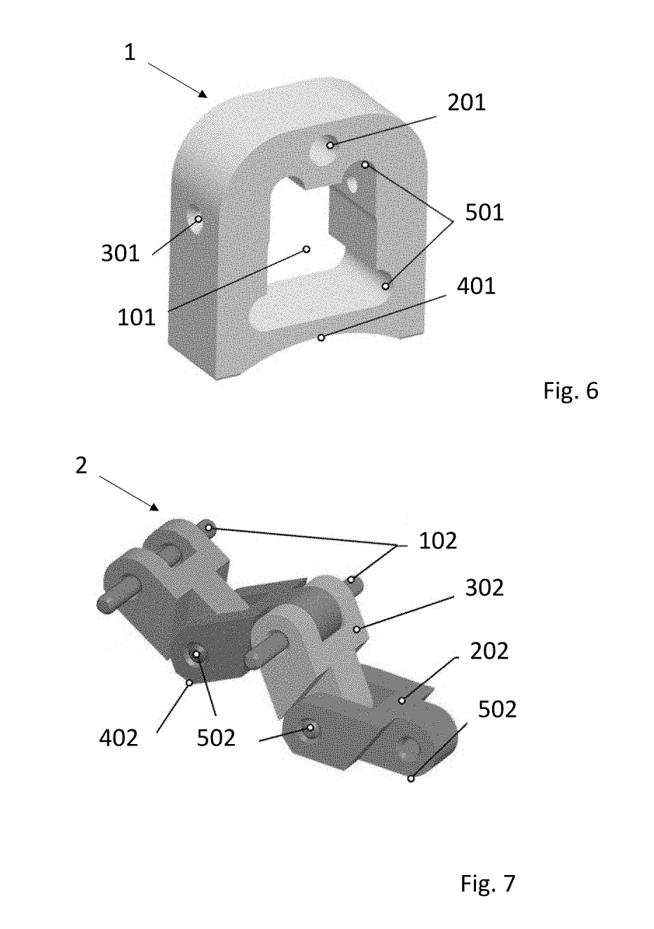

The following FIGS. 6 and 7 show with more details the constructional characteristics of one embodiment of the exoskeleton structure provided for each finger in the device according to the present invention and the principle for the configuration of the exoskeleton in the different situations.

More generally, the inventive concept provides a series of differential mechanisms connected with each other which is the base of an underactuated mechanism and that when applied to the hands, performs an adaptive self-configuration very close to the kinematics of human fingers in the activity grasping objects. An underactuated finger is kinematically under-constrained and dynamically unstable, however, when it closes around an object, the finger obtains the missing external constraints and it configures its shape on the object. As a result, in the case of a hand with at least three underactuated fingers (that gives the minimum number of points of contact for constraining an object in the space), an automatic grasping action is generated around the object with a configuration of the fingers suitable for the object and therefore with a higher stability.

Conceptually the device is composed of a series of rigid structures or rigid elements arranged on a row on a back surface of the hand and of the fingers along all their length. The relative movement between said rigid elements aims at straightening the fingers, by means of a tension rod acting on the last element at the distal end of the exoskeleton. The above permits a great flexibility in the adaptation to any finger length.

In a preferred embodiment, the rigid elements are composed of parallelepiped shaped blocks in combination with means limiting the separation distance between the adjacent parallelepiped blocks such to equally distribute straightening forces among each one of said elements/blocks when the finger is flexed. Moreover said separation limiting means reduce the undesired mobility of the blocks such as particularly a rotation about the longitudinal axis of the finger.

In a preferred embodiment the invention advantageously provides a chain as the separation limiting means.

With such solution the rotation along the longitudinal plane is prevented while the blocks are free to pivot in the sagittal plane. Moreover the chain passes into a central passage opening of each parallelepiped block generating a backbone-like structure.

In particular, in order to guarantee the highest adaptability of the exoskeleton to the corresponding finger, each parallelepiped block in the longitudinal direction of the finger has a relatively thin dimension, namely smaller than the dimensions of the block in the other two directions. The thickness is selected such to meet different conflicting needs. On one side the reduction of the thickness of the block in the longitudinal direction of the finger increases the adaptability of the exoskeleton to the shape of the back side of the finger on which the exoskeleton is in contact. On the other side, an excessive reduction of the thickness dimensions of the blocks in the longitudinal direction of the finger complicates the structure both as regards the number of pieces and as regards the configuration of the distance limiting means and the relevant means for the fastening to the individual rigid elements.

As it will be seen in the specific shown embodiment, the dimension of the blocks in the longitudinal direction of the fingers is such to maintain the structure strong enough and to allow the individual blocks to be articulated to a limiting element made in the form of a chain, all without compromising the adaptability of the exoskeleton structure to the morphology and kinematics of the finger.

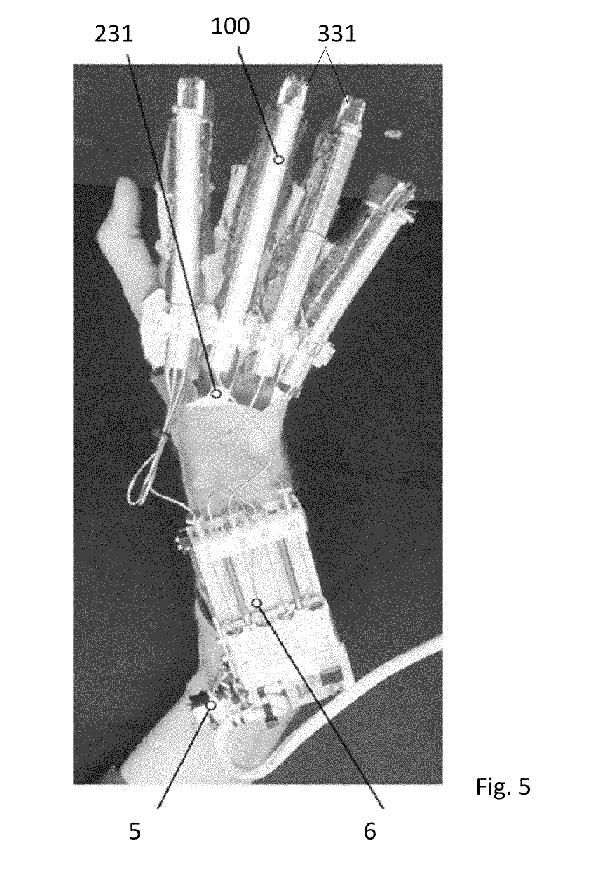

FIG. 5 shows a top plan view of the device coupled to one hand. In this configuration the device allows index, middle, ring and little fingers to be operated. The operating modes can be selected both for moving the fingers all together and for operating individually each finger by moving it independently from the other ones. Obviously other movement combinations can be easily set. The thumb is considered to be constrained by the use of orthosis in a position allowing objects to be picked up, that is allowing it to operate in opposition to the other fingers.

FIG. 5 further shows the motor driving the pull cables denoted by 5 and a unit transmitting the driving motion of the motor to the individual cables 3 denoted by 6. Both the motor and the transmission unit are made with wearable unit, advantageously provided fastened to the arm.

By going in the details of FIGS. 6 and 7, each parallelepiped block 1 of the series is identical to the other blocks. In the central part of each block 1 there is provided an opening 101 with a substantially rectangular shape. The opening has such a shape and size to provide a space sufficient for the passage of the element limiting the distance between the blocks which is composed of the chain 2 a segment thereof being shown in FIG. 7. Said chain 2 has links hinged with each other about axes parallel to each other and that in the mounted condition are substantially parallel to the axes of the angular movement of the joints between the phalanges of the finger. Said chain 2 runs along the whole row of blocks 1. A pull cable 3 passes through each block 1 and is caused to pass through a central opening 201 in the upper side of the block 1 delimiting the central opening 101. The chain 2 is a kind of backbone of the finger and it is constrained to each block 1 by a pivot pin 102. Said pin advantageously is the pivot pin of two successive links of the chain that protrudes past said links with end portions intended to rotatably engage corresponding seats 301 in the two opposite sides of the corresponding block perpendicular to said pin 102. In order to adapt itself to the shape of the finger and to keep an equal pressure along the whole back surface of the finger, the lower side of the blocks intended to rest on the back side of the finger is shaped in an anatomically curved manner by means of a curved notch 401 particularly like a sector of a cylinder.

The structure of the chain is composed of two types of links very similar to each other and connected in series alternately to each other said two types of links being denoted by 202, 302 in FIG. 7. The two types of links are different in that they have a different shape of the abutment surfaces denoted by 402 and 502. The two links 202 and 302 of different type form a chain segment iteratively repeating along the length of the chain and only one block 2 is articulated to the first link 302 of the relevant link segment formed of the two links 202, 302. This occurs as described above by mounting the block on the projecting parts of the axis of articulation of the first link 302 to the second link 202 of the adjacent segment, while the two links 202 and 302 of each segment are articulated with each other by a pin 602 ending flush with the external sides of the link.

Considering the kinematics of the chain and the shape thereof, as it results from FIG. 6, the substantially rectangular central opening has extensions in the form of enlargement grooves denoted by 501 that adapt such opening to the maximum encumbrance section of the chain 2.

A constructional example provides parallelepiped blocks with dimensions of 4.8 mm of thickness, 13 mm of height that is in the direction perpendicular to the articulation axes and 12 mm of width that is in a direction parallel to the articulation axes.

The links of the chain 2 are long as 7.8 mm, have a thickness of 3 mm and a width of 6 mm. With such dimensions it is still advantageously possible to use a standard manufacturing process and this considerably reduces the manufacturing costs.

Links 302 are articulated to the corresponding block 1 by means of a pin with a length of 12 mm.

As regards the kinematic behavior of the device two cases have to be considered:

The first case is about the last parallelepiped block 1′ which is connected to the tip of the finger, and also the pull cable 3 is connected thereto.

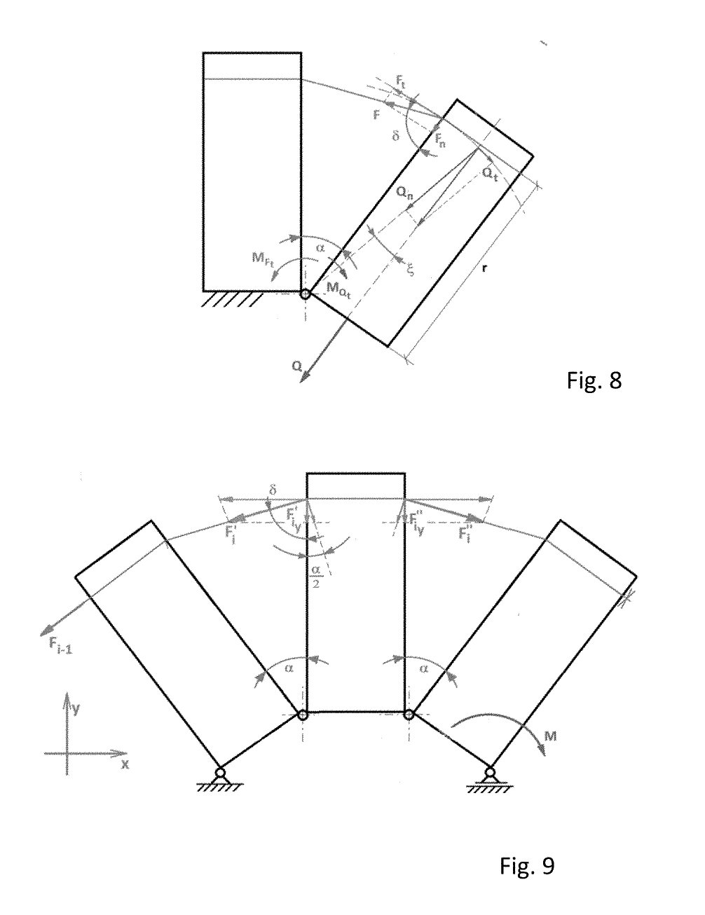

The situation is summarized in FIG. 8. Such block 1′ pulls the finger and it acts as the end element of the kinematic chain and it acts for lifting the weight generated by the tip of the finger and this is denoted by Q in FIG. 8. In order to lift the finger, therefore by the last block, the force F applied by the cable 3 has to generate a torque higher than the weight exerted by the fingertip and i.e.

MFT>MQT, where MFT=Ft*r and MQT=Qt*r

where:

MFT is the torque exerted by the pulling force;

Ft is the component of the pulling force perpendicular to radius r;

Qt is the component of the weight perpendicular to the radius;

MQT is the torque exerted by the weight generated by the finger;

r is the radius between the articulation axis of the joint of the finger and the axis of the pull cable.

In the worst case the force Ft will have the smallest values for the maximum opening angle α=34.5° made possible by the structure of the exoskeleton 100. In such situation the pulling force exerted by the last block 1′ is calculated as being about 0.95 of the force applied by the cable 3, while the MQT torque is calculated as a constant value equal to a factor of 0.29 of the force with which the fingertip opposes the extension/lifting.

The second case provides the behavior of the intermediate blocks 1 and it is schematically shown in FIG. 9. By pulling the cable 3, a force Fi′ and Fi″ is generated. The orientation of said two forces is perpendicular to the orientation of the cable immediately before entering the i-th block. The vertical components of this force denoted by Fiy′ and Fiy″ act for pushing the i-th block downwardly and therefore for straightening all the structure and the finger. Thus the device extends the fingers by pulling the finger upwardly and at the same time by pushing all the back surface of the finger downwardly.

The amount of blocks used in the system causes the angle a to change. Generally the smaller the angle a is, the more force is transmitted to the fingertip due to the lower friction, while the generated vertical force pushing the finger downwardly is smaller. The length of each series of blocks is easily adjustable and in the shown example 111 blocks in total are provided to form the exoskeleton of four fingers.

As already mentioned in the introduction of the present description, in combination with the mechanical part there are provided sensors for the movement and for the exerted force. These sensors can be selected among the sensors available on the market and this is a selection made by the person skilled in the art within his/her basic technical knowledge.

This is valid also for the provision of a control and processing unit that can be made in the form of a processing unit wherein a control and processing program is loaded.

Said unit can be worn by the patient or it can be remote and connected to a data transmission unit that receives and transmits the data collected by the sensors and that transmits the configuration and control signals to the device, that is to the motor and to the transmission unit.

Several possibilities are known and widely used in distributing the control tasks and the processing tasks among several units of which a remote and fixed part and a wearable part. The devices can be dedicated electronics interfacing with the device and having a section for the interface with general processing devices of the retail type such as personal computer, tablet, smart phones and other ones. In this case the person skilled in the art can carry out any selection considered as being the most suitable for the specific case both as regards costs and as regards comfort of use and functionalities. Simply by using its basic technical knowledge.

A particular embodiment provides a program for managing the rehabilitation exercises that are implemented in the form of a game, the objectives of the game being defined such to progressively increase the difficulty level of the exercises. Advantageously by means of the present sensors, the processing unit that executes the program can automatically evaluate the achievement of specific difficult levels and therefore can automatically set new difficult levels.

The interfaces between the possible dedicated processing and control electronics and possible traditional processing and control electronics, in both the cases where the processing and control devices are fixed or worn, can be of the wireless type or of the cable type.

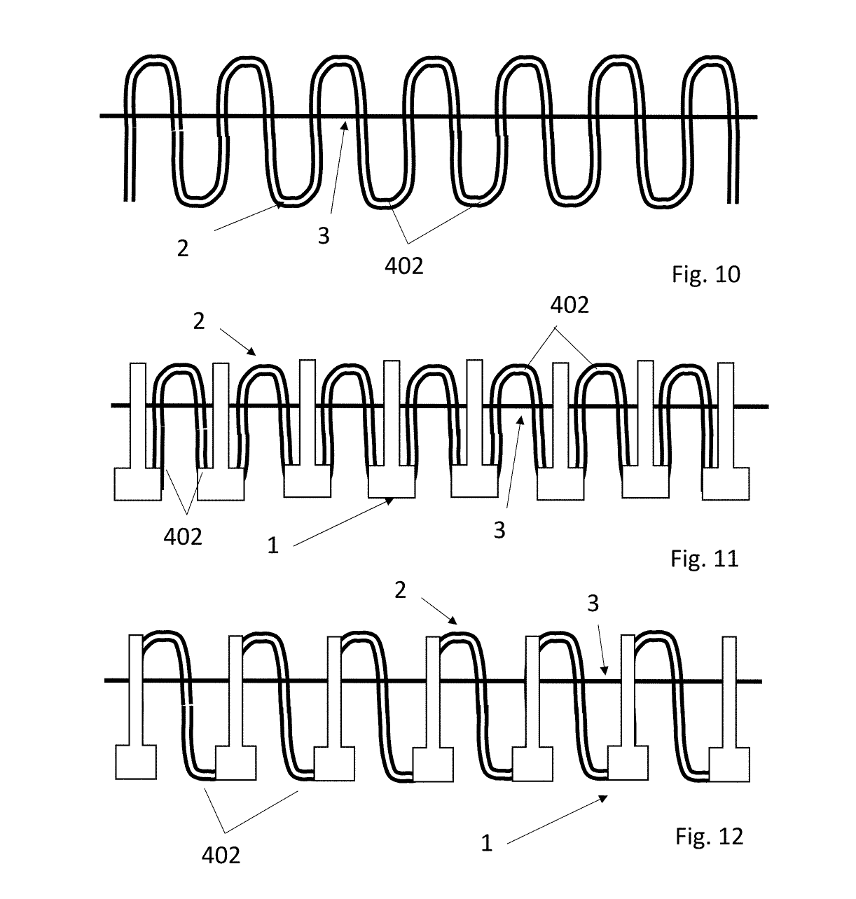

With reference to FIG. 10, it shows a variant embodiment wherein the chain 2 is composed of a continuous flexible element that forms the sequence of flexible connections between the individual rigid elements 1 of the exoskeleton.

The element 2 can be made in several manners and according to the non-limitative shown embodiment it is a band made of one-piece flexible material.

The flexible connection element is a continuous element wherein it is possible to integrate in several manners and at predetermined distances the several rigid elements 1 such to form an exoskeleton with the functional characteristics substantially equal to those of the preceding embodiment.

Such as shown in FIGS. 11 and 12 the rigid elements can be fastened at different points of the flexible element 2.

The distances between the individual rigid elements 1 can be selected on the basis of the conditions of use.

In one embodiment the flexible connection element 2 can be made of only one material or of several materials for example combinations of layers applied for giving particular mechanical behaviors.

Moreover the rigid elements 1 and the element 2 connecting them can be made as a continuous solution for example made of a same material or different materials, particularly by means of injection, co-injection, over-molding processes and other rapid prototyping techniques.

By using plastic materials or other materials that can be formed with co-molding or over-molding processes, it is possible for example to make the exoskeleton according to FIGS. 11 and 12 by using materials that are different for the rigid elements 1 and for the sequence of flexible elements, thus optimizing the mechanical characteristics of the material forming said two parts with reference to their function and therefore to the stresses they are subjected to.

As it is clear the exoskeleton structure is made of the sequence of rigid elements 1 and of the sequence of flexible connection elements that connect the individual rigid elements with each other in a flexible manner, forming a kind of film-like hinge.

The numeral 3 denotes the pull/extension cable that acts in the same manner as described for the preceding embodiment.

Still according to a further variant, the material used for the flexible connection elements of the sequence 2 of said elements can have not only flexibility characteristics, but also an elastic behavior tending to recover the initial shape once it is biased in a tensile, compression manner and also possibly other manners. Such behavior can be set by acting on the material that can be made of a particular combination of plastic materials or other one or by acting on the dimensions of the elements such as thickness, width, length, on the shape and also on the fact of providing different parts coupled to each other, such as for example a structure composed of different layers coupled with each other, at least at the areas where a certain elastic response is required or desired.

By means of such elastic characteristics it is possible to obtain a higher adaptation to the different conditions of use.

Finally, it has to be noted that the element 2 of FIG. 10 can be both an element like the chain 2 of the previous embodiment, to which the rigid elements 1 have to be associated, which can also be of the type described in the previous embodiment, but at the same time it can be a basic integrated form of an exoskeleton, wherein the coil-shaped band acts as the rigid element and flexible element connecting the rigid elements with each other, the rigid elements being composed of the parts oriented substantially transversely to the longitudinal extension and the flexible connection elements being composed of the curved sectors of the coil shape.

The invention claimed is:

1. An aid device for movement and rehabilitation of one or more fingers of a hand, comprising:
an exoskeleton configured to be positioned on the back of at least one finger and to be mechanically constrained to the finger; and
a motorized system exerting a movement or a change in a configuration of said exoskeleton,
wherein said exoskeleton comprises an underactuated modular structure having a plurality of substantially identical rigid elements arranged on a row and articulated with each other,
wherein said rigid elements are arranged in said row one behind another along a longitudinal axis parallel to a longitudinal extension of the finger and are articulated with each other to follow one or more finger movements selected from the group consisting of extension, flexion, adduction, abduction, or opposition of thumb,
wherein said motorized system comprises one or both of pulling or pushing elements that act on one or more of said rigid elements of the exoskeleton to produce said one more finger movements,
wherein said rigid elements of said exoskeleton are constrained with each other by a continuous longitudinal element comprising a chain having links articulated with each other according to first parallel articulation axes, said first parallel articulation axes being oriented parallel to articulation axes of finger phalanges in an extension and closure movement thereof, and
wherein the rigid elements pivot with respect to each other according to second parallel articulation axes, said second parallel articulation axes being oriented parallel to the articulation axes of the finger phalanges, and being movable near and away from each other, each of said rigid elements being pivotally fastened about an axis of articulation of two links of the chain;
further comprising at least one pulling element passing through the rigid elements and freely slidable therethrough, said pulling element being flexible and constrained at one end to an end element placed at a distal end of the finger and at an opposite end to a pulling member.

2. The aid device according to claim 1, wherein each plurality of rigid elements comprises a variable number of rigid elements or translates along an alignment axis to modify a length of the chain depending on different dimensions of a patient's fingers.

3. The aid device according to claim 1, wherein said rigid elements comprise blocks or plates of a substantially rectangular annular shape, having a predetermined thickness, and are provided with a support surface and a through hole for a longitudinal articulation element, inner walls of the through hole at posts oriented perpendicular to the articulation axes being provided with holes which engage opposite ends of a pin provided on a chain element and extending on opposite sides of the chain element at an articulation axis, and wherein each rigid element is provided with at least one through hole obtained in a direction of the adjacent rigid elements and configured to be passed through by the pulling element.

4. The aid device according to claim 1, wherein the end element placed at the distal end of the finger is locked and constrained to the pulling element.

5. The aid device according to claim 3, wherein each rigid element is articulated at an articulation axis of a link of the chain element, there being provided at least one intermediate articulation axis between two adjacent rigid elements, a rigid element being not articulated on said intermediate articulation axis.

6. The aid device according to claim 1, wherein the rigid elements are mounted on a supporting structure coupled to the hand and comprising a stiffening disc adapted to adhere to a palm of the hand.

7. The aid device according to claim 6, wherein the supporting structure is configured as a continuous glove.

8. The aid device according to claim 6, wherein the supporting structure comprises at least one fingerstall end segment for the distal end of the finger and at least one intermediate annular segment fastenable to the finger.

9. The aid device according to claim 1, wherein the pulling elements comprise at least one actuating unit for a pulling action which is mounted on a back side of a wristband, said pulling elements being operatively connectable to each pull cable so that the pulling action is contemporaneously exerted by all pull cables, by each pull cable selectively and independently from each other, or by sub-groups of the pull cables, wherein the pulling action is exerted contemporaneously for the pull cables of a corresponding sub-group.

10. The aid device according to claim 1, further comprising a differential mechanism interposed between at least one pulling unit and at least two pulling elements for controlling at least two pulling element with a single pulling unit.

11. The aid device according to claim 1, further comprising position sensors and force sensors connected to an electronic unit operating and controlling movement depending on signals detected by said position and force sensors.

12. The aid device according to claim 11, wherein the exoskeleton is coupled to forefinger, ring finger, middle finger and little finger, and the pulling elements comprise four actuating units, each of said actuating units acting on a single finger, the electronic unit being configured to independently control the exoskeleton on each finger.

13. The aid device according to claim 1, further comprising members driving and transmitting exoskeleton movements corresponding to adduction and/or abduction movements and opposition movements of the thumb, said members being individually activatable or deactivatable to let the adduction/abduction movements and the thumb movements free, to lock the fingers in a predetermined position, or to actively actuate finger movement.

14. The aid device according to claim 1, further comprising a system that executes a logic program managing and controlling the exoskeleton configured as a videogame or a predetermined program, and a system that changes difficulty level thereof or of an associated action based on achievement of predetermined motor performances.

15. The aid device according to claim 1, wherein the chain articulating the rigid elements with each other is composed of a continuous and one-piece element that forms a flexible connection element composed of bridges of a material or of film-shaped hinges to which the rigid elements are coupled and distributed spaced from each other along a longitudinal extension of said connection element to generate an overall deformation of the exoskeleton according to a preferential flexion plane.

16. The aid device according to claim 15, wherein the flexible connection element is made at least of two different materials.

17. The aid device according to claim 15, wherein the flexible connection element is made at least partially or for its entire extension of an elastically flexible material.

18. An aid device for movement and rehabilitation of one or more fingers of a hand, comprising:
an exoskeleton configured to be positioned on a back of at least one finger and to be mechanically constrained to the finger; and
a motorized system exerting a movement or a change in a configuration of said exoskeleton,
wherein said exoskeleton comprises an underactuated modular structure, comprising a plurality of substantially identical rigid elements arranged on a row and articulated with each other,
wherein said rigid elements are arranged in said row one behind another along a longitudinal axis parallel to a longitudinal extension of the finger and are articulated with each other to follow at least one or more finger movements selected from the group consisting of extension, flexion, adduction, abduction, opposition of thumb,
wherein said motorized system for at least a part of said movements comprises pulling and pushing elements that act on one or more of said rigid elements of the exoskeleton to produce said at least one finger movement, and
wherein said rigid elements of said exoskeleton are constrained to each other by a continuous longitudinal element composed of a flexible or elastic sequence of connection elements, the individual rigid elements being coupled to the continuous longitudinal element at expected distances from each other, said continuous longitudinal element being made to have an overall deformation along a preferential flexion plane.

19. The aid device according to claim 18, wherein the preferential flexion plane is oriented to correspond to articulation axes of phalanges of the finger in an extension and closure movement thereof, and wherein at least one pulling element is passing through the rigid elements and is freely slidable therethrough, said pulling element being flexible and constrained at one end to an end element placed at a distal end of the finger and at an opposite end to a pulling element.

20. The aid device according to claim 18, wherein each plurality of rigid elements comprises a variable number of rigid elements or translates along an alignment axis to modify a length of the chain depending on different dimensions of a patient's fingers.
